(19) United States
(12) Patent Application Publication
(10) Pub. No.: US 2025/0162412 A1
(43) Pub. Date: May 22, 2025

(54) VEHICLE OVERHEAD CONSOLE BRACKET

(71) Applicant: DAEHAN SOLUTION CO., LTD, Incheon (KR)

(72) Inventors: CHOONG HO KWON, SEOUL (KR); LEE BANG WON, INCHEON (KR)

(21) Appl. No.: 18/932,079

(22) Filed: Oct. 30, 2024

(30) Foreign Application Priority Data
Nov. 20, 2023 (KR) KR 10-2023-016109

(51) Int. Cl. B60K 35/00

(52) U.S. Cl. CPC B60K 35/00; B60K 2360/688; B60K 2360/771; B60K 2360/816

(57) ABSTRACT

When an overhead console (OHC) bracket is manufactured, since a support may be additionally formed on a portion in which there is concern that an adhesive applied to a surface of a headliner to attach a wiring installed near the OHC bracket will flow down, the adhesive may be applied to the support to attach the wiring without the adhesive flowing down. By adding the support to a front edge portion of the OHC bracket to apply the adhesive to the support without being directly applied to an inclined surface of the headliner for attaching the wiring, it is possible to firmly attach and safely use the wiring at a predetermined position without the adhesive flowing down. Also, by adding and integrally forming a stopper at the edge of the OHC bracket, the wiring can be prevented from being easily detached or misaligned, thereby making attachment work easy.

### CROSS-REFERENCE TO RELATED APPLICATION

This application claims priority to and the benefit of Korean Patent Application No. 10-2023-0161091, filed on Nov. 20, 2023, the disclosure of which is incorporated herein by reference in its entirety.

### BACKGROUND

### 1. Field of the Invention

The present invention relates to a vehicle overhead console (OHC) bracket, and more specifically, to a vehicle OHC bracket, in which a support may be formed at an upper edge portion of the OHC bracket, which is positioned at an edge portion of a headliner, in which there is a concern that an adhesive applied for attaching a wiring installed near the OHC bracket flows down along an inclined surface of the headliner, thereby not only preventing the adhesive applied to the headliner for mounting the wiring from further flowing down from the support to accurately attach the wiring to predetermined positions with appropriate attachment strength but also preventing problems that may occur due to the adhesive flowing down and sticking to or contaminating surrounding areas.

### 2. Discussion of Related Art

In general, wirings are mounted on a surface of a vehicle headliner facing a roof panel to supply power to various electrical and electronic devices mounted in a vehicle indoors, headliner, etc.

In this case, the wirings are mounted in various ways, such as provided in Patent Documents 1 to 3 below, to be firmly and safely attached to the surface of the headliner so as not to be easily detached or peeled off due to vibration or noise.
(Patent Document 1) Korean Patent Registration No. 10-2130293

When an overhead console (OHC) bracket mounted to fixedly support an OHC to a headliner is manufactured, an elastic part may be formed to fix a wiring, and thus when only the OHC bracket is fixed to the headliner, the wiring may be easily and conveniently installed or detached using the elastic part without any separate means or fixture. In particular, since at least one tension hole is formed to pass through a central portion of a width of the elastic part, the elastic part may easily bend and straighten to stably and elastically support and fix the wiring, and in addition, even when the elastic part is long, the wiring may be easily fixed. In addition, since a guide part is formed to protrude to be bent outward from an edge of the elastic part, the wiring may be easily fitted into the cover part by pushing away the guide part, thereby making assembly work easy and convenient.
(Patent Document 2) Korean Laid-Open Patent No. 10-2022-0160195

A wiring may be fixed by forming a fixing protrusion at each of both sides of a bracket around the wiring and forcibly fitting a flexible band member having a mounting hole formed on one surface thereof onto the fixing protrusion, or the wiring may be easily and conveniently fixed according to a diameter of the wiring by forming the fixing protrusion protruding from one side of the bracket around the wiring and integrally forming the band member having a plurality of mounting holes formed to pass therethrough to be assembled to the fixing protrusion on the other side of the bracket. In addition, since among a plurality of brackets mounted on a headliner, in particular, a pillar bracket that supports a pillar A installed at the corner of the headliner and an OHC bracket installed at a front middle portion of the headliner are included, any bracket that supports the wiring may be applied.
(Patent Document 3) Korean Laid-Open Patent No. 10-2020-0127066

By forming an elastic bracket on a lamp cover so that a wiring section that electrically connects an opening of a headliner to a lamp may be fixed, the wiring section may be assembled at a predetermined position quickly and without incurring any assembly-related defects. In particular, since the elastic bracket is mounted by being forcibly fitted into the lamp cover, and the wiring may be removed and installed utilizing elasticity, anyone may easily and quickly assemble or separate the elastic bracket and wiring at the predetermined position. In this case, since the elastic bracket has a “C”-shaped width cross section to install the wiring while being forcibly spread and has an accommodation part formed at one edge thereof to be forcibly fitted onto a pressure-reducing protrusion formed on the lamp cover, the elastic bracket has a simple structure and thus can be easily manufactured and conveniently used.

### Related Art Documents

### Patent Documents

(Patent Document 1) Korean Patent Registration No. 10-2130293 (registered date: Jun. 30, 2020)
(Patent Document 2) Korean Laid-Open Patent No. 10-2022-0160195 (published date: Dec. 6, 2022)
(Patent Document 3) Korean Laid-Open Patent No. 10-2020-0127066 (published date: Nov. 10, 2020)

### SUMMARY OF THE INVENTION

As described above, when the wiring is mounted by being attached to the head liner, the following problems occur.
(1) Since a surface of a headliner is formed in a three-dimensionally complex shape, it is difficult to attach a wiring, which has a certain degree of bending, to the complex shape.
(2) In particular, when applying an adhesive to the surface of the headliner to attach the wiring, and a slope of the surface of the headliner to be applied is too steep, there is a concern that the adhesive will flow down.
(3) This is because the amount of the adhesive is not sufficient secured at a point at which the wiring is attached, and thus there is a limitation related to firmly attaching and fixing the wiring.
(4) In addition, such adhesive flowing down may stick to other nearby parts or the surface of the headliner to cause the other parts to lose their functions, thereby leading to product defects.
(5) In addition, when a component that needs to be detachably attached is mounted on the headliner, a situation in which the component cannot be detached due to such adhesive flowing down occurs
(6) In particular, since the wiring installed near an overhead console (OHC) installed on a front middle portion of the headliner has a severe slope at a front edge portion of the headliner, the adhesive tends to flow down severely when mounting the wiring.

Considering such a point, the present invention is directed to, when manufacturing the OHC bracket, providing a vehicle OHC bracket, in which a support may be additionally formed on a portion in which there is a concern that an adhesive applied to a surface of the headliner to attach a wiring installed near the OHC bracket will flow down, thereby neatly and firmly attaching the wiring without the adhesive flowing down as a result of applying the adhesive to the support and safely using the OHC bracket.

In particular, the present invention is directed to providing a vehicle OHC bracket, in which a support may be added and integrally formed at a front edge portion of the OHC bracket having a severe inclination to apply the adhesive used for attaching a wiring to the support without being directly applied to an inclined surface of a headliner to be used for attaching the wiring, thereby firmly attaching the wiring to a predetermined position without the adhesive flowing down and safely using the wiring.

In addition, the present invention is directed to providing a vehicle OHC bracket, in which a stopper may be added and integrally formed on an edge of the support to prevent a wiring caught on the support from easily being detached or misaligned, thereby making attachment work easy and accurately attaching the wiring to a predetermined position.

A vehicle OHC bracket according to the present invention includes a bracket body (100) installed on a surface, which faces a roof panel, at an edge of an opening (O) formed in a headliner (H), wherein a support (110) is integrally formed to protrude from at least a portion of an edge of the bracket body (100) to support a wiring (W) installed along a periphery of the bracket body (100), and the support (110) is formed to protrude from a front edge of the bracket body (100) positioned at an edge of the headliner (H).

A surface of the support (110) may be formed to be inclined at 5 to 20° toward a front edge of the headliner (H) with respect to a horizontal plane in a state in which the headliner (H) is mounted so that an adhesive is prevented from flowing down to the headliner (H).

The support (110) has a stopper (111) formed at an edge thereof to prevent the wiring (W) from being detached from the support (110).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a vehicle to show a mounting position of a headliner on which a vehicle overhead console (OHC) according to the present invention is mounted;

FIG. 2 is a perspective view showing the headliner on which the vehicle OHC bracket according to the present invention is mounted;

FIG. 3 is a perspective view showing a state of being separated from the headliner to show the mounting position of the vehicle OHC bracket according to the present invention;

FIG. 4 is a perspective view showing a configuration of the vehicle OHC bracket according to the present invention;

FIG. 5 is a plan view of a portion of the headliner showing a state in which the vehicle OHC bracket according to the present invention is mounted on the headliner; and

FIG. 6 is a cross-sectional view along line A-A in FIG. 5.

### DETAILED DESCRIPTION OF EXEMPLARY EMBODIMENTS

Hereinafter, exemplary embodiments according to the present invention will be described in detail with reference to the accompanying drawings. Prior to the description, the terms or words used in the specification and claims should not be construed as being limited to their usual or dictionary meanings and should be construed as meanings and concepts consistent with the technical spirit of the present invention according to a principle in which the inventors can appropriately define the concepts of the terms in order to describe their inventions by the best method.

Therefore, since embodiments described in the present specification and the configurations shown in the drawings are only the most exemplary embodiments of the present invention and do not represent all of the technical spirit of the present invention, it should be understood that various equivalents and modified examples capable of replacing the embodiments and the configurations may be present at the time that this application is filed.

### Configuration Of Vehicle Overhead Console (OHC) Bracket

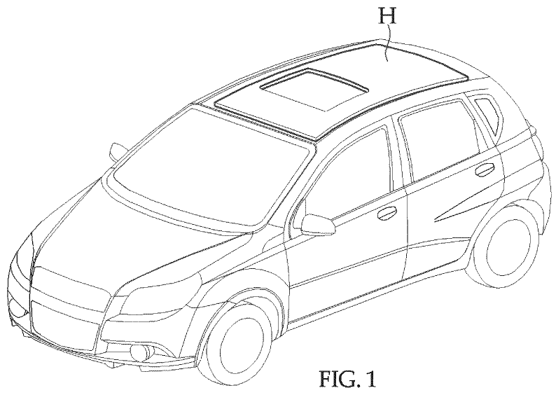

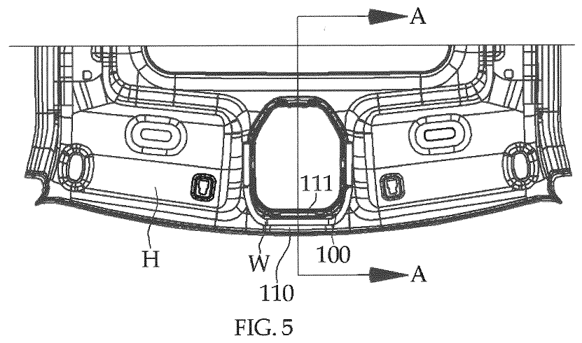

As shown in FIGS. 1 to 6, a vehicle OHC bracket according to the present invention includes a bracket body 100 mounted on an edge portion of an opening O formed in a headliner H in order to mount an OHC.

In particular, since the bracket body 100 is formed so that a support 110 may be integrally formed to protrude from a portion of an edge thereof and the support 110 may support a wiring W installed near the bracket body 100, it is possible to prevent an adhesive applied to attach the wiring W on a surface of a headliner H from flowing down in order to firmly attach the wiring W to a predetermined position and prevent the adhesive flowing down from contaminating an area near the wiring.

In this case, since the support 110 may be integrally formed to protrude from a front edge portion, which has the most severe inclination, of the bracket body 100, it is possible to prevent the wiring W from being lifted up due to poor attachment and prevent the occurrence of noise caused by the lifted-up wiring W hitting the surface of the headliner H.

In addition, since a stopper 111 is formed at an edge of the support 110, it is possible to prevent the wiring W placed on the support 110 from being easily detached or misaligned, thereby accurately attaching and using the wiring W at the predetermined position.

In addition, since the support 110 is formed to be inclined towards a front portion of the headliner H at an angle of 5 to 20° with respect to a horizontal plane in a state in which the headliner His mounted on a roof panel, even when the adhesive flows down from the headliner H, the support 110 receives the adhesive flowing down to prevent the adhesive from flowing down further.

Hereinafter, such a configuration will be described in more detail with reference to the accompanying drawings as follows. Here, the drawing symbol “H” denotes a headliner, “O” denotes an opening formed to pass through and mount an OHC, and “W” denotes a wiring installed near the OHC bracket.

### A. Bracket Body

As shown in FIGS. 1 to 3, the bracket body 100 is mounted to face the roof panel at an edge of the opening O formed to mount the OHC in the headliner H installed to face the roof panel in a vehicle indoors.

Therefore, the bracket body 100 is manufactured in a closed loop shape that is the same as or similar to the shape of the opening O, and any type of rib is integrally formed to protrude in order to reinforce structural rigidity.

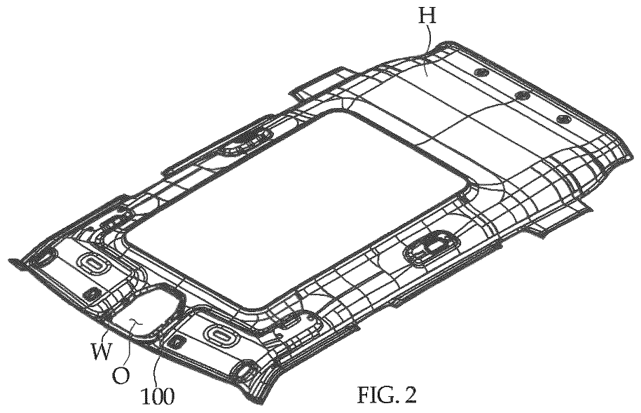

Meanwhile, as shown in FIGS. 2 to 6, the wiring W is mounted at an edge portion of the bracket body 100, and the support 110 is integrally formed to support the wiring W and prevent the adhesive used when attaching the wiring W from flowing down due to gravity.

### B. Support

As shown in FIGS. 2 to 5, the support 110 is integrally formed to protrude from the bracket body 100 to fixedly support the wiring W installed near the bracket body 100.

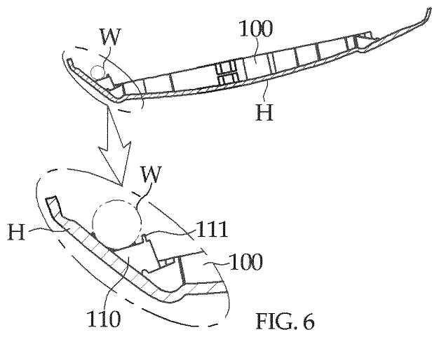

In particular, since the support 110 is integrally formed to protrude from a portion in which there is a concern that an adhesive will flow down due to inclination of the surface of the headliner H when directly applying the adhesive to the headliner H in order to attach the wiring W due to the severe inclination of the headliner H as shown in FIG. 6, it is possible to prevent the adhesive from flowing down due to gravity and contaminating a surrounding area and to firmly attach and safely and conveniently use the wiring W.

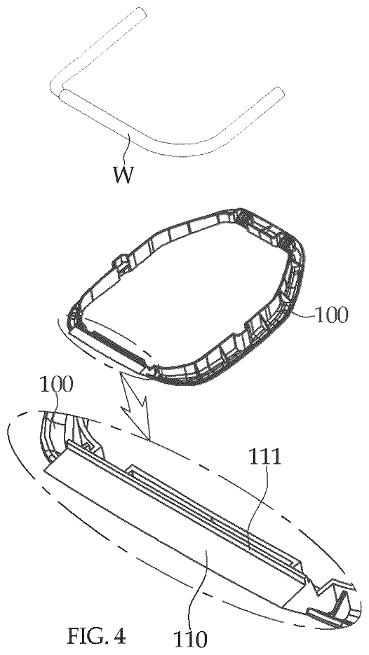

In this case, as shown in FIGS. 4 and 6, the support 110 may be formed so that a surface supporting the wiring W has a horizontal state to prevent the adhesive from flowing down and may be formed to have a certain degree of slope and may be used by being manufactured to have a slope at which the adhesive may not flow down. In an exemplary embodiment of the invention, the support 110 is preferably formed to be inclined towards a front portion of the headliner H at an angle of 5 to 20° with respect to the surface of the headliner H in a state in which the headliner H is mounted on the roof panel. This is to prevent the adhesive from flowing down further from the support 110 even when the adhesive flows down from the headliner H as well as prevent the adhesive from flowing down by allowing the adhesive flowing down to the support 110 to gather at a portion in which the headliner H meets the support 110.

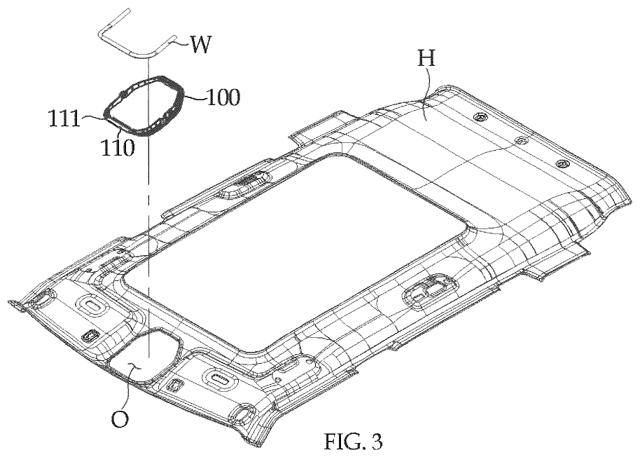

In addition, in an exemplary embodiment of the present invention, as shown in FIGS. 3 to 6, the support 110 is preferably formed integrally to protrude from a portion of the bracket body 100 installed at the front edge of the headliner H. This is because since the edge portion of the headliner H has a steeper slope than other portions, when an adhesive is applied to the above portion, a larger amount of adhesive may flow down more quickly due to gravity.

Lastly, in an exemplary embodiment of the present invention, as shown in FIGS. 4 to 6, the support 110 has the stopper 111 integrally formed to protrude from the edge portion thereof. Here, the stopper 111 may prevent the wiring W placed on the support 110 from being detached from or misaligned with the support 110 and prevent the adhesive from flowing down to the headliner H even when a large amount of adhesive is applied on the support 110.

A vehicle OHC bracket according to the present invention has the following effects.
(1) By integrally forming a support to protrude from a portion of an edge of the OHC bracket and placing and attaching a wiring on the support, it is possible to prevent an adhesive required for attaching the wiring from flowing down from the support.
(2) This can prevent the attachment strength of the wiring from being reduced as long as the adhesive flows down as well as prevent defective problems in which the OHC bracket cannot be used because the adhesive flowing down contaminates an area near a headliner or is attached to other components.
(3) In particular, by forming the support to protrude from a front edge portion having a severe inclination among edges of the OHC bracket, it is possible to solve a problem in which the wiring installed on the above edge is not firmly attached due to the lack of the adhesive and prevent the occurrence of noise.
(4) By forming a stopper at an edge portion of the support, it is possible to prevent the wiring from being detached from or misaligned with the support and prevent the adhesive from flowing down further.

As described above, according to the present invention, when manufacturing the OHC bracket, by integrally forming the support to support the wiring installed near the OHC bracket and attaching the wiring on the support, it is possible to prevent the adhesive, which is applied to the surface of the headliner to attach the wiring, from flowing down to the slope of the headliner.

What is claimed is:

1. A vehicle overhead console (OHC) bracket comprising a bracket body (100) installed on a surface, which faces a roof panel, at an edge of an opening (O) formed in a headliner (H),
wherein a support (110) is integrally formed to protrude from at least a portion of an edge of the bracket body (100) to support a wiring (W) installed along a periphery of the bracket body (100), and
the support (110) is formed to protrude from a front edge of the bracket body (100) positioned at an edge of the headliner (H).

2. The vehicle OHC bracket of claim 1, wherein a surface of the support (110) is formed to be inclined at 5 to 20° toward a front edge of the headliner (H) with respect to a horizontal plane in a state in which the headliner (H) is mounted so that an adhesive is prevented from flowing down to the headliner (H).

3. The vehicle OHC bracket of claim 1, wherein the support (110) has a stopper (111) formed at an edge thereof to prevent the wiring (W) from being detached from the support (110).

4. The vehicle OHC bracket of claim 2, wherein the support (110) has a stopper (111) formed at an edge thereof to prevent the wiring (W) from being detached from the support (110).
